(19) United States
(12) Patent Application Publication
(10) Pub. No.: US 2025/0087410 A1
(43) Pub. Date: Mar. 13, 2025

(54) MATRIX INTEGRATED TRANSFORMER WITH BUILT-IN LEAKAGE INDUCTANCE

(71) Applicant: VIRGINIA TECH INTELLECTUAL PROPERTIES, INC., Blacksburg, VA (US)

(72) Inventors: Feng Jin, Blacksburg, VA (US); Ahmed Nabih, Blacksburg, VA (US); Qiang Li, Blacksburg, VA (US)

(21) Appl. No.: 18/462,723

(22) Filed: Sep. 7, 2023

(51) Int. Cl. H01F 27/30; H01F 27/24; H02M 3/335

(52) U.S. Cl. CPC H01F 27/306; H01F 27/24; H02M 3/335

(57) ABSTRACT

Power converters with integrated transformers and resonant inductors are described. An example integrated transformer can be electrically coupled between a primary-side converter stage and a secondary-side converter stage in a power converter. The integrated transformer can include a magnetic core with plurality of core legs, a primary winding extending around each of the plurality of core legs, and a secondary winding extending around each of the plurality of core legs. A winding direction of the primary winding is alternated between adjacent core legs among the plurality of core legs, and a winding direction of the secondary winding is alternated between adjacent core legs among the plurality of core legs. Additionally, a number of winding turns of the primary winding and a number of winding turns of the secondary winding on a first core leg is different than on a second core leg among the plurality of core legs.

### BACKGROUND

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

### SUMMARY

Power converters with integrated transformers and resonant inductors are described herein. An example integrated transformer can be electrically coupled between a primary-side converter stage and a secondary-side converter stage in a power converter. The integrated transformer can include a magnetic core with plurality of core legs, a primary winding extending around each of the plurality of core legs, and a secondary winding extending around each of the plurality of core legs. A winding direction of the primary winding is alternated between adjacent core legs among the plurality of core legs, and a winding direction of the secondary winding is also alternated between adjacent core legs among the plurality of core legs. Additionally, a number of winding turns of the primary winding around the plurality of core legs is different on at least two core legs among the plurality of core legs.

In other aspects of the embodiments, a total number of winding turns of the primary winding and the secondary winding around a first core leg is different than around a second core leg among the plurality of core legs. In other aspects, the integrated transformer includes a first unit transformer and a second unit transformer. The first unit transformer includes a first total number of winding turns of the primary winding and the secondary winding around a first pair of core legs among the plurality of core legs, and the second unit transformer includes a second, different total number of winding turns of the primary winding and the secondary winding around a second pair of core legs among the plurality of core legs.

In other aspects, the integrated transformer includes a first unit transformer, a second unit transformer, and a third unit transformer. A first polarity of magnetomotive force (MMF) of the first unit transformer and of the third unit transformer is different than a second polarity of the MMF of the second unit transformer. In other aspects, the magnetic core comprises a first air gap for a first core leg among the plurality of core legs and a second, different air gap for a second core leg among the plurality of core legs.

The integrated transformers described herein are designed to achieve a net reduction or cancellation of leakage flux within a magnetic core, resulting in reduced core loss, higher power density, and other benefits as compared to other integrated transformers. The integrated transformers also offer increased efficiency in a range of different power converters. Additionally, the integrated transformers are scalable and facilitate higher voltage, higher current, and higher power conversion applications.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates an example power converter according to various aspects of the present disclosure.

FIG. 2A illustrates an example arrangement and placement of windings with a magnetic core in a unit transformer for the power converter shown in FIG. 1 according to various aspects of the present disclosure.

FIG. 2B illustrates an example arrangement and placement of windings with a magnetic core in another unit transformer for the power converter shown in FIG. 1 according to various aspects of the present disclosure.

FIG. 2C illustrates an example arrangement and placement of windings with a magnetic core in another unit transformer for the power converter shown in FIG. 1 according to various aspects of the present disclosure.

FIG. 3 illustrates an example electrical arrangement of the unit transformers shown in FIGS. 2A-2C according to various aspects of the present disclosure.

FIG. 4A illustrates an example of the integrated transformer shown in FIG. 1 and FIGS. 2A-2C according to various aspects of the present disclosure.

FIG. 4B illustrates an example of the integrated transformer shown in FIG. 1 and FIGS. 2A-2C with the “I” core component omitted from view according to various aspects of the present disclosure.

FIG. 4C illustrates a top down view of an example core component and winding turn directions in the integrated transformer shown in FIG. 1 according to various aspects of the present disclosure.

FIG. 5A illustrates an example arrangement and placement of windings with a another magnetic core in another unit transformer for the power converter shown in FIG. 1 according to various aspects of the present disclosure.

FIG. 5B illustrates an example arrangement and placement of windings with a another magnetic core in another unit transformer for the power converter shown in FIG. 1 according to various aspects of the present disclosure.

FIG. 5C illustrates an example arrangement and placement of windings with a another magnetic core in another unit transformer for the power converter shown in FIG. 1 according to various aspects of the present disclosure.

FIG. 6A illustrates an example of an integrated transformer including the unit transformers shown in FIGS. 5A-5C according to various aspects of the present disclosure.

FIG. 6B illustrates an example of the integrated transformer shown in FIG. 6A with the “I” core component omitted from view according to various aspects of the present disclosure.

FIG. 6C illustrates a top down view of an example core component and winding turn directions in the integrated transformer shown in FIG. 6A according to various aspects of the present disclosure.

FIG. 6D illustrates a side view of the integrated transformer shown in FIG. 6A according to various aspects of the present disclosure.

FIG. 7A illustrates an example matrix integrated transformer according to various aspects of the present disclosure.

FIG. 7B illustrates another example matrix integrated transformer according to various aspects of the present disclosure.

FIG. 8 illustrates other example profiles of core legs according to various aspects of the present disclosure.

FIG. 9 illustrates another example magnetic core component according to various aspects of the present disclosure.

### DETAILED DESCRIPTION

Power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

A range of non-isolated and isolated power converters are known. Examples of non-isolated power converters include buck, boost, buck-boost, and Cuk power converters. A buck or step-down converter is one example of a non-isolated DC-to-DC power converter that could be relied upon for the conversion of power at a higher DC voltage at a lower current rating to a lower DC voltage at a higher current rating. As a switching converter, a buck converter can provide better power efficiency than linear regulators. The efficiency of buck converters can be relatively high, making buck converters a good choice for DC-to-DC power conversion applications used in computers and computing systems.

Many isolated power converters include isolation transformers and, in some cases, transformer-integrated magnetics. A number of isolated power converter topologies are known, and resonant power converters offer higher efficiency through the reduction of switching losses and other benefits. A range of different integrated magnetic devices, such as integrated transformers, have been used for interfacing the primary and secondary converter stages in isolated power converters. Some integrated transformers are designed to provide a series inductance for use in the resonant tank of resonant power converters. This series inductance, which can be formed from the leakage inductance of an integrated transformer, can be relied upon as the resonant inductor in the resonant tank, avoiding the need for a separate resonant inductor.

Wide band gap (WBG) devices, such as Gallium-Nitride (GaN) and Silicon-Carbon (SiC) devices, can operate at higher switching frequencies, greater efficiency, and higher power density than other devices. In many applications, including data center, telecom, energy storage, electric vehicle (EV), wireless power transfer, solid-state transformer, and other applications, WBG devices have been applied to offer a range of benefits. The switching frequency of power converters can be pushed to several hundred kHz or MHz using WBG devices. The use of higher switching frequencies facilitates reduced size and number of passive components, such as magnetics and capacitors, and printed circuit board (PCB) windings can be adopted for planar transformers and inductors.

Some applications for power converters, such as intelligent grids applications, require bi-directional energy transfer. Many onboard chargers (OBCs) of EVs support both grid-to-vehicle energy transfer for in-EV battery charging and vehicle-to-grid energy transfer for intelligent grid functions and power for standalone AC equipment.

The LLC power converter topology is a good candidate for high efficiency and density power converters. However, LLC converters have only one resonant inductor at the primary side, which limits the gain range in the reverse energy transfer direction. The CLLC converter and dual active bridge (DAB) power converter topologies are popular for applications including bi-directional energy transfer, as they have a symmetrical voltage gain range. For the DAB converter, the turn-off current is relatively larger than the CLLC resonant converter, resulting in a more considerable switching loss. For CLLC resonant converters, inductors are required on both sides of the transformer, which increases the complexity and cost of the power converter. The transformers and inductors in CLLC converters often contribute to both a significant extent of the loss in efficiency and the increased size of CLLC converters. Improvements to the magnetic structures in CLLC converters can help to improve the total performance of such converters in terms of both efficiency and power density.

In the context outlined above, power converters with integrated transformers and resonant inductors are described herein. An example integrated transformer can be electrically coupled between a primary-side converter stage and a secondary-side converter stage in a power converter. The integrated transformer can include a magnetic core with plurality of core legs, a primary winding extending around each of the plurality of core legs, and a secondary winding extending around each of the plurality of core legs. A winding direction of the primary winding is alternated between adjacent core legs among the plurality of core legs, and a winding direction of the secondary winding is alternated between adjacent core legs among the plurality of core legs. Additionally, in some cases, a number of winding turns of the primary winding and a number of winding turns of the secondary winding on a first core leg is different than on a second core leg among the plurality of core legs.

The integrated transformers described herein are designed to achieve a net reduction or cancellation of leakage flux within a magnetic core, resulting in reduced core loss, higher power density, and other benefits as compared to other integrated transformers. The integrated transformers also offer increased efficiency in a range of different power converters. Additionally, the integrated transformers are scalable and facilitate higher voltage, higher current, and higher power conversion applications.

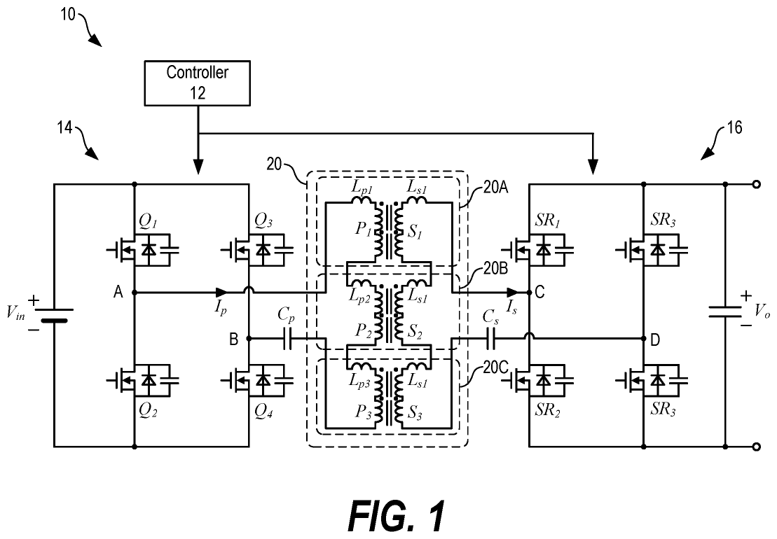

FIG. 1 illustrates an example power converter 10 according to various aspects of the present disclosure. The power converter 10 is illustrated as a representative example of a bi-directional resonant DC-to-DC power converter. In some cases, the power converter 10 can include other components that are not illustrated in FIG. 1, such as additional output converter stages, capacitors, inductors, active devices (e.g., transistors, diodes, etc.), and other components. The power converter 10 can be implemented using a combination of integrated and discrete circuit components, for example, on one or more PCBs. The concepts of matrix integrated transformers with built-in leakage inductance, as described herein, can be applied in the power converter 10, as one example, among other types of power converters. However, the matrix integrated transformer concepts are not limited to use with the power converter 10. The concepts can be applied to a range of different topologies and types of power converters.

The power converter 10 includes a controller 12, a primary-side converter stage 14 (also “converter stage 14”), a secondary-side converter stage 16 (also “converter stage 16”), and an integrated transformer 20 electrically coupled between the primary-side converter stage 14 and the secondary-side converter stage 16. In one mode of operation, an input voltage Vᵢₙ is applied as an input to the power converter 10, and an output voltage Vₒ is generated at an output of the power converter 10. The power converter 10 is bi-directional, however, and power can also be transferred from the secondary-side converter stage 16 to the primary-side converter stage 14.

The power converter 10 can be designed to operate with a wide range of input and output voltages and currents. Example potentials for Vᵢₙ and Vₒ are in the range of tens or hundreds of Volts, and the power converter 10 can operate to transfer power in the range of 5 kW, 10 KW, 15 kW, 20 KW, or more. The integrated transformer 20 and other components of the power converter 10 can be extended (e.g., series- and/or parallel-connected) to offer increased power transfer and the ability to operate with higher potentials, as needed and discussed below. Overall, the power converter 10 is not limited to use with any particular range of voltages or currents, and the integrated transformer concepts described herein can be applied to power converters operating over a range of input and output voltages and power levels.

The primary-side converter stage 14 includes a full bridge arrangement of switching devices Q₁, Q₂, Q₃, and Q₄ and a resonant tank including a primary-side resonant capacitor Cₚ and a primary-side resonant inductor Lₚ. The total inductance of Lₚ is determined by the combined inductances of Lₚ₁, Lₚ₂, and Lₚ₃, which are realized by leakage inductances of the integrated transformer 20, as described below. The switching devices Q₁, Q₂, Q₃, and Q₄ can be embodied as switching transistors, such as insulated-gate bipolar transistors (IGBTs), metal-oxide-semiconductor field-effect transistors (MOSFETs), or other suitable types of switching transistors or active switching devices. The switching devices Q₁, Q₂, Q₃, and Q₄ can be embodied in WBG semiconductor materials, such as GaN and SiC, semiconductor materials, as examples, including GaN/SiC power modules. The switching devices Q₁, Q₂, Q₃, and Q₄ are not limited to any particular type of switching device or devices formed from any particular type of semiconductor materials, however. The operation of the switching devices Q₁, Q₂, Q₃, and Q₄ (e.g., the flow of current through the switching devices Q₁, Q₂, Q₃, and Q₄) can be controlled by gate drive control signals provided by the controller 12. The primary-side converter stage 14 is illustrated to include a full bridge arrangement of switching devices in FIG. 1, but the use of other arrangements of switching devices can also be relied upon in the primary-side converter stage 14. The primary-side converter stage 14 is electrically coupled to the primary side and primary windings of the integrated transformer 20.

The secondary-side converter stage 16 includes a full bridge arrangement of switching devices SR₁, SR₂, SR₃, and SR₄ and a resonant tank including a secondary-side resonant capacitor Cₛ and a secondary-side resonant inductor Lₛ. The total inductance of Lₛ is determined by the combined inductances of Lₛ₁, Lₛ₂, and Lₛ₃, which are realized by leakage inductances of the integrated transformer 20, as described below. The switching devices SR₁, SR₂, SR₃, and SR₄ can be embodied as switching transistors, such as IGBTs, MOSFETs, or other suitable types of switching transistors or active switching devices. The operation of the switching devices SR₁, SR₂, SR₃, and SR₄ (e.g., the flow of current through the switching devices SR₁, SR₂, SR₃, and SR₄) can be controlled by drive control signals provided by the controller 12. The secondary-side converter stage 16 is electrically coupled to the secondary side and secondary windings of the integrated transformer 20.

The controller 12 is configured to generate control signals for the converter stages 14 and 16. The control signals direct the switching (i.e., current or power flow) operation of the switching devices Q₁-Q₄ in the converter stage 14 and the switching operation of the switching devices SR₁-SR₄ in the converter stage 16 at an operating frequency of the power converter 10, which can range among the embodiments. Example operating frequencies for the power converter 10 can range from tens of kHz to several MHz or higher. The switching devices can be operated by pulse width modulation (PWM) control signals generated by the controller 12, as one example. The controller 12 is also configured to direct the transfer (and direction) of power through the power converter 10 based on the control signals for the converter stages 14 and 16. Depending on the mode of operation of the power converter 10, the devices in the converter stages 14 and 16 can be directed to provide power transfer or synchronized voltage rectification. For example, in the forward transfer of power, the devices Q₁-Q₄ in the converter stage 14 can be operated for power switching of the DC Vᵢₙ input voltage across the integrated transformer 20 and the devices SR₁-SR₄ in the converter stage 16 can be operated as synchronous rectifiers to provide the DC Vₒ output voltage. In the reverse transfer of power, the devices SR₁-SR₄ in the converter stage 16 can be operated for power switching across the integrated transformer 20 and the devices Q₁-Q₄ in the converter stage 14 can be operated as synchronous rectifiers.

The integrated transformer 20 includes a magnetic core, a primary winding, and a secondary winding. In the example shown in FIG. 1, the integrated transformer 20 includes elemental or unit transformers 20A, 20B, and 20C. The unit transformer 20A includes a primary winding P₁, a secondary winding S₁, a primary-side resonant inductor Lₚ₁, and a secondary-side resonant inductor Lₛ₁. The unit transformer 20B includes a primary winding P₂, a secondary winding S₂, a primary-side resonant inductor Lₚ₂, and a secondary-side resonant inductor Lₛ₂. The unit transformer 20C includes a primary winding P₃, a secondary winding S₃, a primary-side resonant inductor Lₚ₃, and a secondary-side resonant inductor Lₛ₃.

In the integrated transformer 20, the primary windings P₁-P₃ and the secondary windings S₁-S₃ can be wound, in an interleaved fashion, around a number of core legs of a single or integrated magnetic core. As described in further detail below, the distribution of the windings of the unit transformers 20A, 20B, and 20C among several core legs in the integrated transformer 20 permits the distribution of magnetic flux in the magnetic core, a better solution for heat distribution, the use of higher voltages and currents in the power converter 10, and other benefits. Additionally, the use of a single or integrated magnetic core for all of the unit transformers 20A, 20B, and 20C in the integrated transformer 20 facilitates a reduction in the total volume and size of the magnetics in the power converter 10.

As described in further detail below, the primary winding P₁ and the secondary winding S₁ are wound around a first pair of core legs of the magnetic core in the integrated transformer 20. The primary winding P₂ and the secondary winding S₂ are wound around a second pair of core legs of the magnetic core in the integrated transformer 20. The primary winding P₃ and the secondary winding S₃ are wound around a third pair of core legs of the magnetic core in the integrated transformer 20.

In some cases, the total number of turns of the primary winding P₁ (e.g., N_{P1}P₁) and the secondary winding S₁ (e.g., N_{S1}S₁) around the first pair of core legs is the same as the total number of turns of the primary winding P₂ (e.g., N_{P2}P₂) and the secondary winding S₂ (e.g., N_{S2}S₂) around the second pair of core legs. In other words, the primary to secondary turns ratio N_{P1}P₁:N_{S1}S₁ in the unit transformer 20A is equivalent to the primary to secondary turns ratio N_{P2}P₂:N_{S2}S₂ in the unit transformer 20B because N_{P1}+N_{S1}=N_{P2}+N_{S2}. Similarly, in some cases, the total number of turns of the primary winding P₂ (e.g., N_{P2}P₂) and the secondary winding S₂ (e.g., N_{S2}S₂) around the second pair of core legs is the same as the total number of turns of the primary winding P₃ (e.g., N_{P3}P₃) and the secondary winding S₃ (e.g., N_{S3}S₃) around the third pair of core legs. In other words, the primary to secondary turns ratio N_{P2}P₂:N_{S2}S₂ in the unit transformer 20B is equivalent to the primary to secondary turns ratio N_{P3}P₃:N_{S3}S₃ in the unit transformer 20C because N_{P2}+N_{S2}=N_{P3}+N_{S3}. In this case, N_{P1}+N_{S1}=N_{P2}+N_{S2}=N_{P3}+N_{S3}.

However, in other cases, N_{P1}+N_{S1} in the unit transformer 20A may not be equivalent to N_{P2}+N_{S2} in the unit transformer 20B. Also, N_{P1}+N_{S1} in the unit transformer 20A may not be equivalent to N_{P3}+N_{S3} in the unit transformer 20C. That is, N_{P1}+N_{S1} may be different than N_{P2}+N_{S2}, may be different than N_{P3}+N_{S3}, or may be different than both N_{P2}+N_{S2} and different than N_{P3}+N_{S3}. Similarly, N_{P2}+N_{S2} may be different than N_{P1}+N_{S1}, may be different than N_{P3}+N_{S3}, or may be different than both N_{P1}+N_{S1} and different than N_{P3}+N_{S3}. N_{P3}+N_{S3} may also be different than N_{P1}+N_{S1}, may be different than N_{P2}+N_{S2}, or may be different than both N_{P1}+N_{S1} and different than N_{P2}+N_{S2}. These and other variations can be relied upon to control or tailor the inductances of Lₚ₁, Lₚ₂, and Lₚ₃ and the inductances of Lₛ₁, Lₛ₂, and Lₛ₃ in the integrated transformer 20, as described in further detail below.

In preferred embodiments, the number of turns (e.g., N_{1P1}) of the primary winding P₁ around a first core leg of the first pair of core legs is different than the number of turns (e.g., N_{2P1}) of the primary winding P₁ around a second core leg of the first pair of core legs. Also, in preferred embodiments, the number of turns (e.g., N_{1S1}) of the secondary winding S₁ around the first core leg of the first pair of core legs is different than the number of turns (e.g., N_{2S1}) of the secondary winding S₂ around a second core leg of the first pair of core legs. The number of turns (e.g., N_{1P2}) of the primary winding P₂ around a first core leg of the second pair of core legs is different than the number of turns (e.g., N_{2P2}) of the primary winding P₂ around a second core leg of the second pair of core legs. The number of turns (e.g., N_{1S2}) of the secondary winding S₂ around the first core leg of the second pair of core legs is different than the number of turns (e.g., N_{2S2}) of the secondary winding S₂ around a second core leg of the second pair of core legs. The number of turns (e.g., N_{1P3}) of the primary winding P₃ around a first core leg of the third pair of core legs is different than the number of turns (e.g., N_{2P3}) of the primary winding P₃ around a second core leg of the third pair of core legs. The number of turns (e.g., N_{1S3}) of the secondary winding S₃ around the first core leg of the third pair of core legs is different than the number of turns (e.g., N_{2S3}) of the secondary winding S₃ around a second core leg of the third pair of core legs. These and other variations can be relied upon to control or tailor the inductances of Lₚ₁, Lₚ₂, and Lₚ₃ and the inductances of Lₛ₁, Lₛ₂, and Lₛ₃ in the integrated transformer 20, as described in further detail below.

The primary and secondary windings of the unit transformers 20A-20C are series-connected in the example shown in FIG. 1. That is, the primary winding P₁ is series-connected with the primary winding P₂, and the primary winding P₂ is series-connected with the primary winding P₃. Thus, the primary windings P₁-P₃, collectively, form a single primary winding path across nodes A and B of the converter stage 14. Additionally, the secondary winding S₁ is series-connected with the secondary winding S₂, and the secondary winding S₂ is series-connected with the secondary winding S₃. Thus, the secondary windings S₁-S₃, collectively, form a single secondary winding path across nodes C and D of the converter stage 16.

In other examples, the primary and secondary windings of the unit transformers 20A-20C can be electrically coupled together in other ways. For example, the primary windings P₁-P₃ can be connected in series across nodes A and B of the converter stage 14, and the secondary windings S₁-S₃ can be respectively connected in parallel across nodes C and D of the converter stage 16. Alternatively, the primary windings P₁-P₃ can be respectively connected in parallel across nodes A and B of the converter stage 14, and the secondary windings S₁-S₃ can be connected in series across nodes C and D of the converter stage 16. Other example connections of the unit transformers 20A-20C are described below.

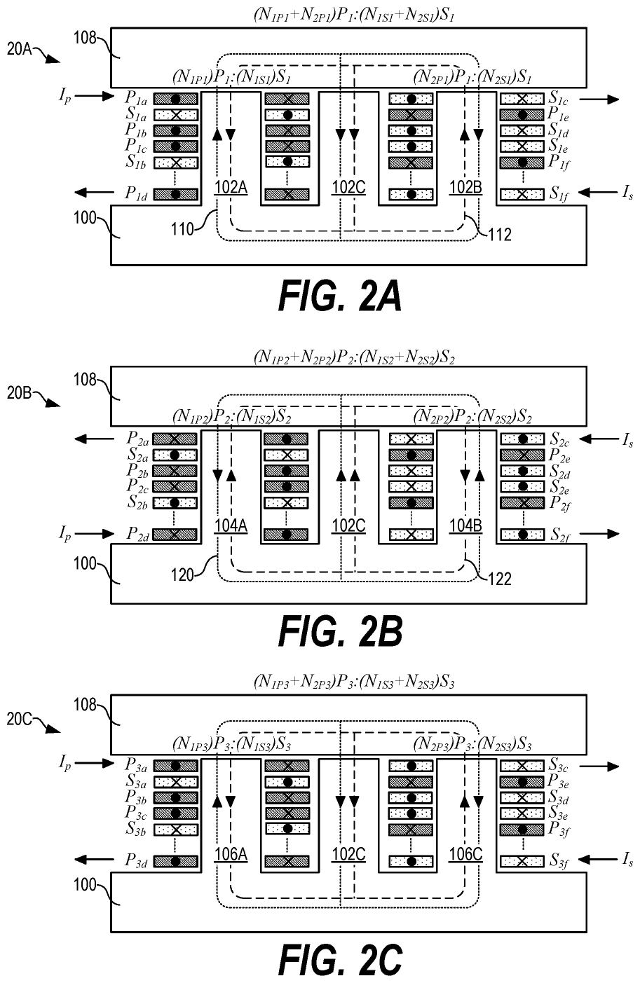

FIG. 2A illustrates an example arrangement and placement of windings with a magnetic core in an integrated transformer for the power converter 10 shown in FIG. 1. More particularly, FIG. 2A illustrates a representative example of the windings and magnetic core of the unit transformer 20A shown in FIG. 1. The unit transformer 20A includes a type of magnetic “EI” core with an “E” core component 100 and an “I” core component 108. In other examples, the unit transformer 20A can be embodied with an “EE” core. Other example transformers implemented with “UI,” “UU,” and other styles of cores are described below.

The magnetic core of the unit transformer 20A can be embodied as a material of high magnetic permeability, such as a ferromagnetic material like iron, laminated silicon steel, laminated iron sheets, or other solid or laminated ferromagnetic ceramic, metal, metal alloy, or related material(s). The “E” core component 100 includes a first core leg 102A, a second core leg 102B, and a central or auxiliary core leg 102C. The first core leg 102A and the second core leg 102B comprise a pair of core legs in the unit transformer 20A (and a first pair of core legs in the integrated transformer 20), and the primary winding P₁ and the secondary winding S₁ extend or wind around the core legs 102A and 102B. The “I” core component 108, which can be arranged with the “E” core component 100 as shown in FIG. 2A, provides a pathway for flux among the core legs 102A-102C of the magnetic core, as described below.

The primary winding P₁ and the secondary winding S₁ extend or wind around the first core leg 102A and around the second core leg 102B. In one example, the primary winding P₁ and the secondary winding S₁ of the unit transformer 20A can be embodied as a stack of metal layers in a PCB, including through-PCB vias and metal traces to electrically couple the P₁ windings together and to electrically couple the S₁ windings together in the PCB as needed. The PCB can include any number of metal layers in the stack, as needed, to implement the number of windings and turns described herein, along with dielectric insulating materials among them in a laminated structure. The turns of the primary winding P₁ and the secondary winding S₁ are interleaved among each other around the core legs 102A and 102B in the example shown in FIG. 2A. The unit transformer 20A is not limited to the particular interleaving arrangement shown in FIG. 2A, however, and other interleaving arrangements can be relied upon.

In the example shown in FIG. 2A, the primary winding P₁ includes four turns (e.g., N_{1P1}=4) around the first core leg 102A and two turns (e.g., N_{2P1}=2) around the second core leg 102B, for a total of six turns (e.g., N_{1P1}+N_{2P1}=6) around the core legs 102A and 102B. In other cases, the total number of turns of the primary winding P₁, or N_{1P1}+N_{2P1}, can be greater or fewer than six. As examples, the total number of turns of the primary winding P₁ around the core legs 102A and 102B (e.g., N_{1P1}+N_{2P1}) can be any number greater than two, including 2, 3, 4, 5, 6, 7, 8, 9, 10, etc. The primary winding P₁ can be implemented in a variety of ways in the stack of metal layers of the PCB. For example, the primary winding P₁ can be implemented as individual metal layers in the PCB, with each metal layer including a single turn around one or both of the core legs 102A and 102B. In other cases, the primary winding P₁ can be implemented as individual metal layers in the PCB, with each metal layer including two or more turns around one or both of the core legs 102A and 102B. These variations can also be applied to the other unit transformers and integrated transformer embodiments described herein.

The secondary winding S₁ includes two turns (e.g., N_{1S1}=2) around the first core leg 102A and four turns (e.g., N_{2S1}=4) around the second core leg 102B, for a total of six turns (e.g., N_{1S1}+N_{2S1}=6) around the core legs 102A and 102B. In other cases, the total number of turns of the secondary winding S₁, or N_{1S1}+N_{2S1}, can be greater or fewer than six. As examples, the total number of turns of the secondary winding S₁ around the core legs 102A and 102B (e.g., N_{1P1}+N_{2P1}) can be any number greater than two, including 2, 3, 4, 5, 6, 7, 8, 9, 10, etc. The secondary winding S₁ can be implemented in a variety of ways in the stack of metal layers of the PCB. For example, the secondary winding S₁ can be implemented as individual metal layers in the PCB, with each metal layer including a single turn around one or both of the core legs 102A and 102B. In other cases, the secondary winding S₁ can be implemented as individual metal layers in the PCB, with each metal layer including two or more turns around one or both of the core legs 102A and 102B. These variations can also be applied to the other unit transformers and integrated transformer embodiments described herein.

The number of turns N_{1P1} of the primary winding P₁ around the first core leg 102A is different than the number of turns N_{2P1} of the primary winding P₁ around the second core leg 102B. Also, the number of turns N_{1S1} of the secondary winding S₁ around the first core leg 102A is different than the number of turns N_{2S1} of the secondary winding S₁ around the second core leg 102B. The unequal distribution of N_{1P1} and N_{2P1} and unequal distribution of N_{1S1} and N_{2S1} can be relied upon to control or tailor the Lₚ₁ and Lₛ₁ inductances of the unit transformer 20A. More particularly, the unequal distribution results in leakage flux flowing through the auxiliary core leg 102C, which results in the Lₚ₁ and Lₛ₁ inductances, as described in further detail below.

The winding or turning direction of the primary winding P₁ and the secondary winding S₁ around the core legs 102A and 102B is also shown in FIG. 2A. In FIG. 2A, the dot “.” signifies current flowing out of the page, and the “X” signifies current flowing into the page. The primary winding P₁ extends in a counter-clockwise direction around the first core leg 102A and extends in a clockwise direction around the second core leg 102B. The secondary winding S₁ extends in a clockwise direction around the first core leg 102A and extends in a counter-clockwise direction around the second core leg 102B. Thus, the magnetic flux 110 generated by the primary winding P₁ circulates in a clockwise direction among the “E” core component 100 and the “I” core component 108 as shown in FIG. 2A. Any magnetic flux 112 generated by the secondary winding S₁ would circulate in a counter-clockwise direction among the “E” core component 100 and the “I” core component 108. At least a portion (e.g., leakage flux) of the magnetic flux 110 and the magnetic flux 112 circulate from the top to the bottom of the page through the auxiliary core leg 102C.

Based on the arrangement and turning directions of the primary winding P₁ and the secondary winding S₁ around the core legs 102A and 102B in the unit transformer 20A, the unit transformer 20A can be described as a type A unit transformer. The polarity of magnetomotive force (MMF) in the type A unit transformer 20A is different (e.g., opposite) than the MMF in unit transformer 20B, as described in further detail below.

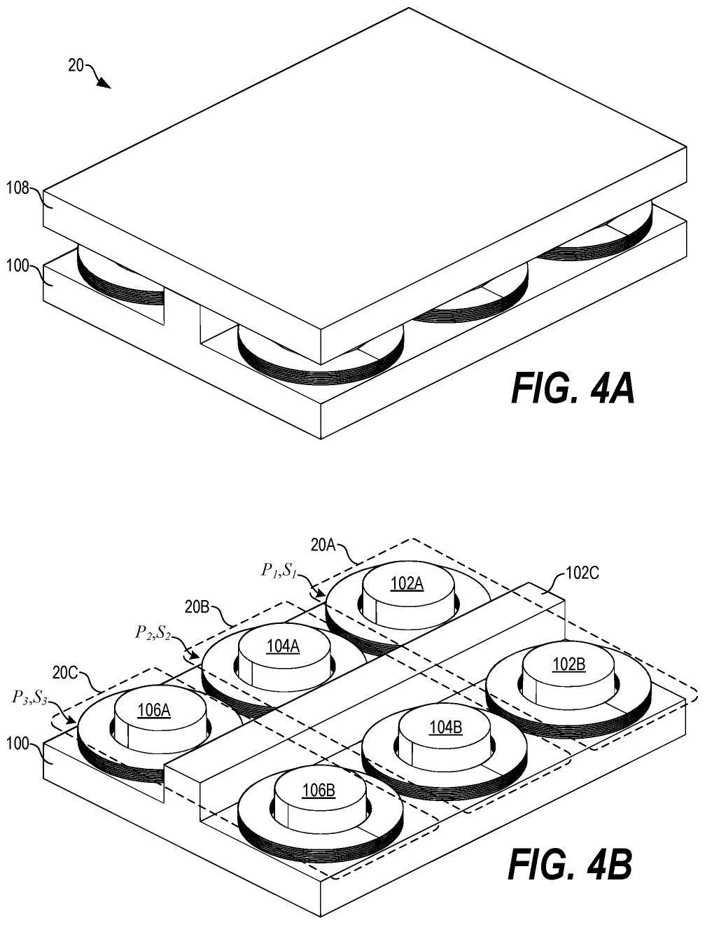

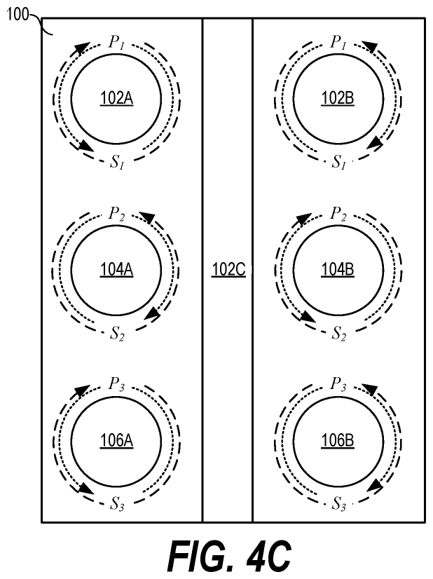

FIG. 2B illustrates a representative example of the windings and magnetic core of the unit transformer 20B shown in FIG. 1. The unit transformer 20B includes the magnetic “EI” core with the “E” core component 100 and the “I” core component 108. As shown in FIG. 2B, the “E” core component 100 also includes a first core leg 104A, a second core leg 104B, and the central or auxiliary core leg 102C. The central or auxiliary core leg 102C extends centrally among all the unit transformers 20A-20C, as shown in FIG. 4B. The first core leg 104A and the second core leg 104B comprise a pair of core legs in the unit transformer 20B (and a second pair of core legs in the integrated transformer 20), and the primary winding P₂ and the secondary winding S₂ extend or wind around the core legs 104A and 104B. The “I” core component 108, which can be arranged with the “E” core component 100 as shown in FIG. 2B, provides a pathway for flux among the core legs 104A and 104B (and among the core legs 102A-102C) of the magnetic core, as described below.

The primary winding P₂ and the secondary winding S₂ extend or wind around the first core leg 104A and around the second core leg 104B. In one example, the primary winding P₂ and the secondary winding S₂ of the unit transformer 20B can be embodied as a stack of metal layers in a PCB, including through-PCB vias and metal traces to electrically couple the P₂ windings together and to electrically couple the S₂ windings together in the PCB as needed. The PCB can include any number of metal layers in the stack, as needed, to implement the number of windings and turns described herein, along with dielectric insulating materials among them in a laminated structure. In some cases, the same PCB can be relied upon to implement the primary windings P₁ and P₂ and the secondary windings S₁ and S₂ in both the unit transformers 20A and 20B. The turns of the primary winding P₂ and the secondary winding S₂ are interleaved among each other around the core legs 104A and 104B in the example shown in FIG. 2B. The unit transformer 20B is not limited to the particular interleaving arrangement shown in FIG. 2B, however, and other interleaving arrangements can be relied upon.

In the example shown in FIG. 2B, the primary winding P₂ includes four turns (e.g., N_{1P2}=4) around the first core leg 104A and two turns (e.g., N_{2P2}=2) around the second core leg 104B, for a total of six turns (e.g., N_{1P2}+N_{2P2}=6) around the core legs 104A and 104B. In other cases, the total number of turns of the primary winding P₂, or N_{1P2}+N_{2P2}, can be greater or fewer than six. The primary winding P₂ can be implemented in a variety of ways in the stack of metal layers of the PCB. For example, the primary winding P₂ can be implemented as individual metal layers in the PCB, with each metal layer including a single turn around one or both of the core legs 104A and 104B. In other cases, the primary winding P₂ can be implemented as individual metal layers in the PCB, with each metal layer including two or more turns around one or both of the core legs 104A and 104B.

The secondary winding S₂ includes two turns (e.g., N_{1S2}=2) around the first core leg 104A and four turns (e.g., N_{2S2}=4) around the second core leg 104B, for a total of six turns (e.g., N_{1S2}+N_{2S2}=6) around the core legs 104A and 104B. In other cases, the total number of turns of the secondary winding S₂, or N_{1S2}+N_{2S2}, can be greater or fewer than six. The secondary winding S₂ can be implemented in a variety of ways in the stack of metal layers of the PCB. For example, the secondary winding S₂ can be implemented as individual metal layers in the PCB, with each metal layer including a single turn around one or both of the core legs 104A and 104B. In other cases, the secondary winding S₂ can be implemented as individual metal layers in the PCB, with each metal layer including two or more turns around one or both of the core legs 104A and 104B.

The number of turns N_{1P2} of the primary winding P₂ around the first core leg 104A is different than the number of turns N_{2P2} of the primary winding P₂ around the second core leg 104B. Also, the number of turns N_{1S2} of the secondary winding S₂ around the first core leg 104A is different than the number of turns N_{2S2} of the secondary winding S₁ around the second core leg 104B. The unequal distribution of N_{1P2} and N_{2P2} and unequal distribution of N_{1S2} and N_{2S2} can be relied upon to control or tailor the Lₚ₂ and Lₛ₂ inductances of the unit transformer 20B. More particularly, the unequal distribution results in leakage flux flowing through the auxiliary core leg 102C, which results in the Lₚ₂ and Lₛ₂ inductances (and the Lₚ₁ and Lₛ₁ inductances), as described in further detail below.

The winding or turning direction of the primary winding P₂ and the secondary winding S₂ around the core legs 104A and 104B is also shown in FIG. 2B. In FIG. 2B, the dot “.” signifies current flowing out of the page, and the “X” signifies current flowing into the page. The primary winding P₂ extends in a clockwise direction around the first core leg 104A and extends in a counter-clockwise direction around the second core leg 104B. The secondary winding S₂ extends in a counter-clockwise direction around the first core leg 104A and extends in a clockwise direction around the second core leg 104B. Thus, the magnetic flux 120 generated by the primary winding P₂ circulates in a counter-clockwise direction among the “E” core component 100 and the “I” core component 108 as shown in FIG. 2B. Any magnetic flux 122 generated by the secondary winding S₁ would circulate in a clockwise direction among the “E” core component 100 and the “I” core component 108. At least a portion (e.g., leakage flux) of the magnetic flux 120 and the magnetic flux 122 circulate from the bottom to the top of the page through the auxiliary core leg 102C. Based on the arrangement and turning directions of the primary winding P₂ and the secondary winding S₂ around the core legs 104A and 104B in the unit transformer 20B, the unit transformer 20B can be described as a type B unit transformer. The polarity of MMF in the type B unit transformer is different (e.g., opposite) than the MMF in the type A transformer.

The unit transformer 20C shown in FIG. 2C can be implemented as a type A transformer, similar to that shown in FIG. 2A but replacing the primary winding P₁ with the primary winding P₃ and replacing the secondary winding S₁ with the secondary winding S₃. FIG. 2C illustrates a representative example of the primary winding P₃ and the secondary winding S₃ and the magnetic core of the unit transformer 20C shown in FIG. 1. As shown in FIG. 2C, the unit transformer 20C is implemented as a type A transformer, similar to the unit transformer 20A shown in FIG. 2A, but replacing the primary winding P₁ with the primary winding P₃ and replacing the secondary winding S₁ with the secondary winding S₃.

The unit transformers 20A-20C can be implemented as separate components with separate magnetic cores. However, it can be challenging to assemble multiple core pieces of three separate “EI” cores together with good tolerance control, and the power density can be negatively impacted as more space is required. Thus, according to the embodiments described herein, the unit transformers 20A-20C are integrated and formed together as the integrated transformer 20 for increased power density and reduced size.

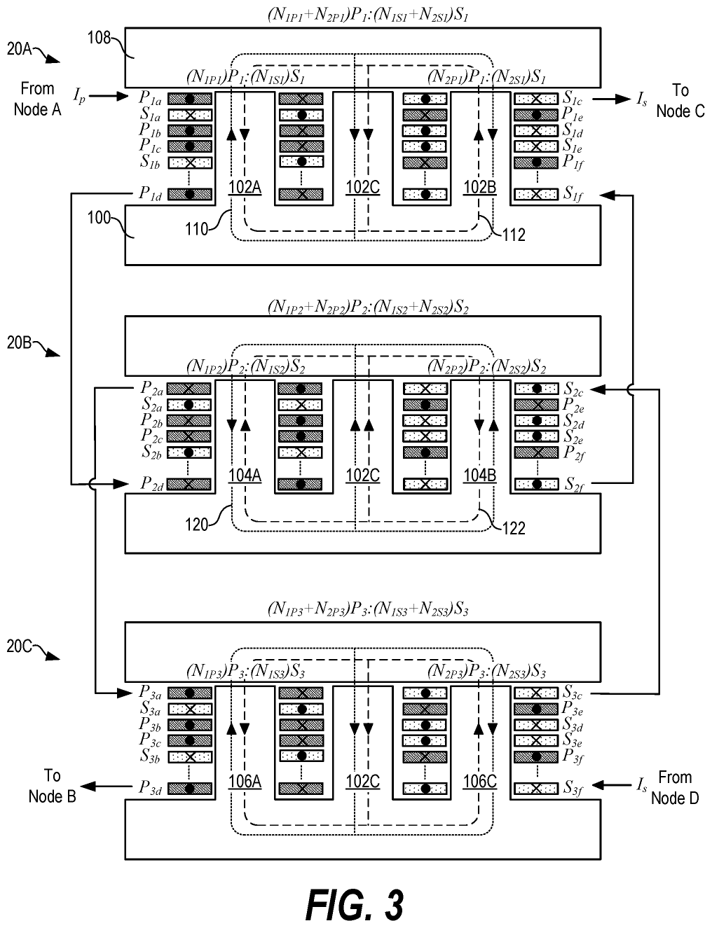

FIG. 3 illustrates an example electrical arrangement of the unit transformers 20A-20C shown in FIGS. 2A-2C according to various aspects of the present disclosure. The primary and secondary windings of the unit transformers 20A-20C are series-connected in the example shown in FIG. 3. That is, the primary winding P₁ is series-connected with the primary winding P₂, and the primary winding P₂ is series-connected with the primary winding P₃. Thus, the primary windings P₁-P₃, collectively, form a single primary winding path across nodes A and B of the converter stage 14 shown in FIG. 1. Additionally, the secondary winding S₁ is series-connected with the secondary winding S₂, and the secondary winding S₂ is series-connected with the secondary winding S₃. Thus, the secondary windings S₁-S₃, collectively, form a single secondary winding path across nodes C and D of the converter stage 16 shown in FIG. 1.

The electrical connections between the unit transformers 20A-20C are illustrated as a representative example in FIGS. 2A-2C. The connections can be formed in any suitable way that maintains the flow of current in the primary windings P₁-P₃ around the core legs 102A, 102B, 104A, 104B, 106A, and 106B in the manner described above with reference to FIGS. 2A-2C. Particularly, the primary winding P₁ extends in a counter-clockwise direction around the core leg 102A and extends in a clockwise direction around the core leg 102B. The primary winding P₂ extends in a clockwise direction around the core leg 104A and extends in a counter-clockwise direction around the core leg 104B. The primary winding P₃ extends in a counter-clockwise direction around the core leg 106A and extends in a clockwise direction around the core leg 106B.

The connections are also formed to maintain the flow of current in the secondary windings S₁-S₃ around the core legs 102A, 102B, 104A, 104B, 106A, and 106B in the manner described above with reference to FIGS. 2A-2C. Particularly, the secondary winding S₁ extends in a clockwise direction around the core leg 102A and extends in a counter-clockwise direction around the core leg 102B. The secondary winding S₂ extends in a counter-clockwise direction around the core leg 104A and extends in a clockwise direction around the core leg 104B. The secondary winding S₃ extends in a clockwise direction around the core leg 106A and extends in a counter-clockwise direction around the core leg 106B.

Besides the electrical arrangement of the unit transformers 20A-20C shown in FIGS. 2A-2C, the primary and secondary windings of the unit transformers 20A-20C can be electrically coupled together in other ways. For example, the primary windings P₁-P₃ can be connected in series across nodes A and B of the converter stage 14, and the secondary windings S₁-S₃ can be respectively connected in parallel across nodes C and D of the converter stage 16. Alternatively, the primary windings P₁-P₃ can be respectively connected in parallel across nodes A and B of the converter stage 14, and the secondary windings S₁-S₃ can be connected in series across nodes C and D of the converter stage 16.

In other aspects of the embodiments, the total number of turns of the primary winding P₁ and the total number of turns of the secondary winding S₁ in the unit transformer 20A can be different than the total number of turns of the primary winding P₂ and the total number of turns of the secondary winding S₂ in the unit transformer 20B. In other words, N_{1P1}+N_{2P1} can be different than N_{1P2}+N_{2P2}, and N_{1S1}+N_{2S1} can be different than N_{1S2}+N_{2S2}. Additionally, the total number of turns of the primary winding P₂ and the total number of turns of the secondary winding S₂ in the unit transformer 20B can be different than the total number of turns of the primary winding P₃ and the total number of turns of the secondary winding S₃ in the unit transformer 20C. In other words, N_{1P2}+N_{2P2} can be different than N_{1P3}+N_{2P3}, and N_{1S2}+N_{2S2} can be different than N_{1S3}+N_{2S3}.

Generally, the integrated transformer 20 can include a first unit transformer including a first number of primary and secondary windings and a second unit transformer including a second and different number of primary and secondary windings. These and other variations can be relied upon to control or tailor the inductances of Lₚ₁, Lₚ₂, and Lₚ₃ and the inductances of Lₛ₁, Lₛ₂, and Lₛ₃ in the integrated transformer 20, as described in further detail below. These variations can also be applied to the other integrated transformer embodiments described herein.

In other examples, the total N_{P1} (i.e., N_{1P1}+N_{2P1}) in the unit transformer 20A can be equal to the total N_{P2} (i.e., N_{1P2}+N_{2P2}) in the unit transformer 20B, and the total N_{P2} (i.e., N_{1P2}+N_{2P2}) in the unit transformer 20B can be equal to the total N_{P3} (i.e., N_{1P3}+N_{2P3}) in the unit transformer 20C. Additionally, the total N_{S1} (i.e., N_{1S1}+N_{2S1}) can be equal to the total N_{S2} (i.e., N_{1S2}+N_{2S2}), and the total N_{S2} (i.e., N_{1S2}+N_{2S2}) can be equal to the total N_{S3} (i.e., N_{1S3}+N_{2S3}). Under those conditions, N_{1P2} can be different than both N_{1P1} and N_{1P3}, and N_{2P2} can be different than both N_{2P1} and N_{2P3}. Also under those conditions, N_{1S2} can be different than both N_{1S1} and N_{1S3}, and N_{2S2} can be different than both N_{2S1} and N_{2S3}. Generally, the number of turns of the primary winding around the first core leg in one of the unit transformers 20A, 20B, and 20C can be different than the number of turns of the primary winding around the first core leg in another one of the unit transformers 20A, 20B, and 20C. Similarly, the number of turns of the primary winding around the second core leg in one of the unit transformers 20A, 20B, and 20C can be different than the number of turns of the primary winding around the second core leg in another one of the unit transformers 20A, 20B, and 20C. Further, the number of turns of the secondary winding around the first core leg in one of the unit transformers 20A, 20B, and 20C can be different than the number of turns of the secondary winding around the first core leg in another one of the unit transformers 20A, 20B, and 20C. Similarly, the number of turns of the secondary winding around the second core leg in one of the unit transformers 20A, 20B, and 20C can be different than the number of turns of the secondary winding around the second core leg in another one of the unit transformers 20A, 20B, and 20C. Table A below shows examples of these arrangements, but the integrated transformer embodiments are not limited to the examples shown in Table A.

TABLE A
Example Winding Arrangements

| Unit | Unit |
|---|---|
| Transformers | Transformer |
| 20A and 20C | 20B |
| 5P3S + 3P5S | 7P1S + 1P7S |
| 5P3S + 3P5S | 6P1S + 1P6S |
| 5P3S + 3P5S | 5P1S + 1P5S |
| 5P3S + 3P5S | 6P2S + 2P6S |
| 5P3S + 3P5S | 5P2S + 2P5S |
| 5P3S + 3P5S | 4P2S + 2P4S |
| 5P3S + 3P5S | 5P3S + 3P5S |
| 5P3S + 3P5S | 4P3S + 3P4S |
| 5P3S + 3P5S | 3P3S + 3P3S |
| 5P3S + 3P5S | 4P4S + 4P4S |

FIG. 4A illustrates an example of the integrated transformer 20 shown in FIG. 1 and FIGS. 2A-2C, and FIG. 4B illustrates the integrated transformer 20 with the “I” core component 108 omitted from view. The magnetic core of the integrated transformer 20 can be embodied as a material of high magnetic permeability, such as a ferromagnetic material like iron, laminated silicon steel, laminated iron sheets, or other solid or laminated ferromagnetic ceramic, metal, metal alloy, or related material(s). The core component 100 is referenced as a type of “E” core component with reference to each of the unit transformers 20A-20C, but the core component 100 includes more core legs than a typical “E” core. The core component 100 includes the first pair of core legs 102A and 102B for the unit transformer 20A, the second pair of core legs 104A and 104B for the unit transformer 20B, and the third pair of core legs 106A and 106B for the unit transformer 20C. The core component 100 also includes the auxiliary core leg 102C, which extends through a center of each of the unit transformers 20A-20C. As best shown in FIG. 4B, the core component 100 is formed as an integrated combination of three “E” cores, merged together.

The stacks of the primary windings P₁-P₃ and the secondary windings S₁-S₃ are illustrated as a representative example in FIGS. 4A and 4B. The electrical connections among the primary windings P₁-P₃ and the secondary windings S₁-S₃ are omitted from view in FIGS. 4A and 4B for simplicity. In practice, the primary windings P₁-P₃ and the secondary windings S₁-S₃ can be formed in other sizes, shapes, and styles. In one example, the primary windings P₁-P₃ and the secondary windings S₁-S₃ of the integrated transformer 20 can be embodied as a stack of metal layers in a PCB, including through-PCB vias and metal traces to electrically couple the windings together in the PCB as needed. The PCB can include any number of metal layers in the stack, as needed, to implement the number of windings and turns described herein, along with dielectric insulating materials among them (not shown) in a laminated structure. In other examples, the windings of the integrated transformer 20 can be implemented using wires (e.g., solid or stranded magnet wire, Litz wire, etc.), copper bars or layers, or in other ways.

As described above, the unequal or unbalanced distribution of the primary winding P₁ and the secondary winding S₁ around the core legs 102A and 102B results in leakage flux, which can flow through the auxiliary core leg 102C. Similarly, the unequal or unbalanced distribution of the primary winding P₂ and the secondary winding S₂ around the core legs 104A and 104B also results in leakage flux, which can flow through the auxiliary core leg 102C. The unequal or unbalanced distribution of the primary winding P₃ and the secondary winding S₃ around the core legs 106A and 106B also results in leakage flux, which can flow through the auxiliary core leg 102C. The leakage flux results in the series inductances Lₚ₁-Lₚ₃ and Lₛ₁-Lₛ₃. The inductances Lₚ₁-Lₚ₃ and Lₛ₁-Lₛ₃ are relied upon, along with the capacitances Cₚ and Cₛ, as resonant tanks in the power converter 10.

However, because the unit transformer 20B is a type B unit transformer and the unit transformers 20A and 20C are type A unit transformers, the integrated transformer 20 experiences a net reduction in the total amount of leakage flux that flows through the auxiliary core leg 102C. In other words, in terms of the total leakage flux density in the integrated transformer 20 (and particularly flowing through the auxiliary core leg 102C), the leakage flux attributed to the unit transformer 20B cancels or opposes at least some of the leakage flux attributed to the unit transformers 20A and 20C. As shown in FIGS. 2A-2C and in FIG. 3, the flux through the auxiliary core leg 102C for the unit transformer 20B flows in a direction that is opposite to that for the unit transformers 20A and 20C, resulting in a net reduction of the total leakage flux density in the integrated transformer 20 and particularly in the auxiliary core leg 102C. The MMF polarity changes among the core legs in the integrated transformer 20 leads to flux cancellation in the auxiliary core leg 102C and forces flux to go from the auxiliary core leg 102C to the adjacent core legs. This leads to a more efficient and even distribution of flux across the core plates.

To further illustrate the arrangement of the primary windings P₁-P₃ and the secondary windings S₁-S₃ in the integrated transformer 20, FIG. 4C illustrates a top down view of the core component 100 and winding turn directions in the integrated transformer 20. As shown in FIG. 4C, the primary winding P₁ extends in a counter-clockwise direction around the core leg 102A and extends in a clockwise direction around the core leg 102B. The primary winding P₂ extends in a clockwise direction around the core leg 104A and extends in a counter-clockwise direction around the core leg 104B. The primary winding P₃ extends in a counter-clockwise direction around the core leg 106A and extends in a clockwise direction around the core leg 106B. The secondary winding S₁ extends in a clockwise direction around the core leg 102A and extends in a counter-clockwise direction around the core leg 102B. The secondary winding S₂ extends in a counter-clockwise direction around the core leg 104A and extends in a clockwise direction around the core leg 104B. The secondary winding S₃ extends in a clockwise direction around the core leg 106A and extends in a counter-clockwise direction around the core leg 106B. In other words, the winding direction (i.e., clockwise vs. counter-clockwise) of the primary winding is alternated between adjacent (i.e., orthogonally-adjacent (and not diagonally-adjacent)) core legs among the core legs 102A, 102B, 104A, 104B, 106A, and 106B. Additionally, the winding direction of the secondary winding is alternated between adjacent core legs among the core legs 102A, 102B, 104A, 104B, 106A, and 106B.

Based on the alternating winding arrangement in the integrated transformer 20, the leakage flux generated by the unit transformer 20B extends or flows in a direction that is opposite than that of the leakage flux generated by the unit transformers 20A and 20C, resulting in a net reduction (e.g., by leakage flux cancellation) of the total flux density and leakage flux density in the integrated transformer 20 and particularly in the auxiliary core leg 102C. The reduced flux density in the integrated transformer 20 results in reduced core loss, reduced heat dissipation, and other benefits in the integrated transformer 20. Additionally, with the reduced flux density, the overall size of the magnetic core of the integrated transformer 20 can be reduced. For example, the thicknesses of the top and bottom plates of the core components 100 and 108 can be reduced. Additionally, as described below, the auxiliary core leg 102C can even be omitted, leading to a further reduction in the size of the integrated magnetics in the power converter 10.

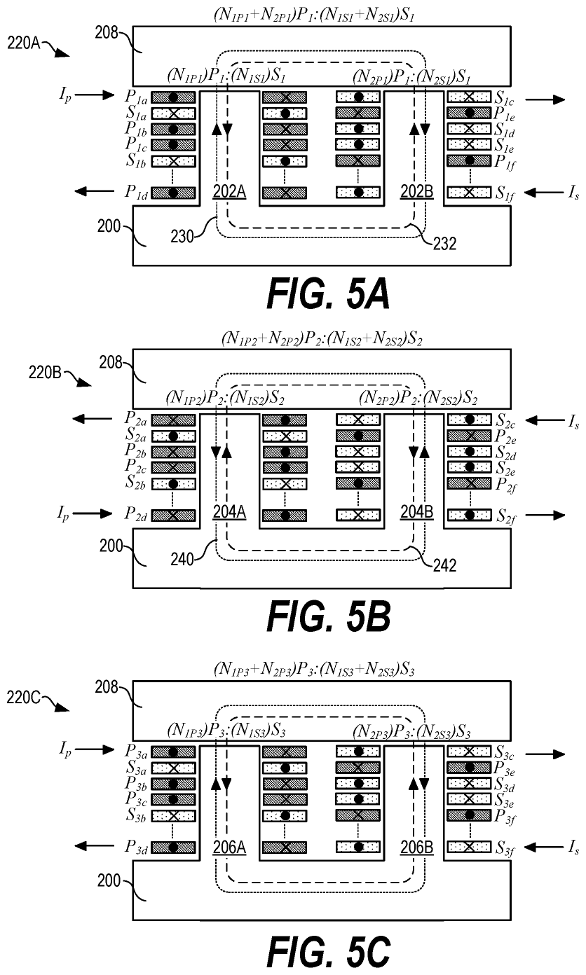

FIGS. 5A-5C illustrates an example arrangement and placement of windings with a another magnetic core in unit transformers 220A-220C for the power converter 10 shown in FIG. 1 according to various aspects of the present disclosure. The unit transformers 220A-220C shown in FIGS. 5A-5C, respectively, are similar to those shown in FIGS. 2A-2C, but the magnetic core used in the unit transformers 220A-220C does not include an auxiliary core leg. The unit transformers 220A-220C shown in FIGS. 5A-5C can be used in place of the unit transformers 20A-20C in the power converter 10 shown in FIG. 1, as one example, among other power converters.

As shown in FIG. 5A, the unit transformer 220A includes a type of magnetic “CI” core with a “C” core component 200 and an “I” core component 208. In other examples, the unit transformer 220A can be embodied with a “CC” core. Other example transformers implemented with “UI,” “UU,” and other styles of cores are also described below. The magnetic core of the unit transformer 220A can be embodied as a material of high magnetic permeability, such as a ferromagnetic material like iron, laminated silicon steel, laminated iron sheets, or other solid or laminated ferromagnetic ceramic, metal, metal alloy, or related material(s). The “C” core component 200 includes a first core leg 202A and a second core leg 202B. The first core leg 202A and the second core leg 202B comprise a pair of core legs in the unit transformer 220A, and the primary winding P₁ and the secondary winding S₁ extend or wind around the core legs 202A and 202B.

The primary winding P₁ and the secondary winding S₁ extend or wind around the first core leg 202A and around the second core leg 202B. In one example, the primary winding P₁ and the secondary winding S₁ of the unit transformer 220A can be embodied as a stack of metal layers in a PCB, including through-PCB vias and metal traces to electrically couple the P₁ windings together and to electrically couple the S₁ windings together in the PCB as needed. The PCB can include any number of metal layers in the stack, as needed, to implement the number of windings and turns described herein, along with dielectric insulating materials among them in a laminated structure. The turns of the primary winding P₁ and the secondary winding S₁ are interleaved among each other around the core legs 202A and 202B in the example shown in FIG. 5A. The unit transformer 220A is not limited to the interleaving arrangement shown in FIG. 5A, and other interleaving arrangements can be relied upon.

In the example shown in FIG. 5A, the primary winding P₁ includes four turns (e.g., N_{1P1}=4) around the first core leg 202A and two turns (e.g., N_{2P1}=2) around the second core leg 202B, for a total of six turns (e.g., N_{1P1}+N_{2P1}=6) around the core legs 202A and 202B. In other cases, the total number of turns of the primary winding P₁, or N_{1P1}+N_{2P1}, can be greater or fewer than six. The primary winding P₁ can be implemented in a variety of ways in the stack of metal layers of the PCB. For example, the primary winding P₁ can be implemented as individual metal layers in the PCB, with each metal layer including a single turn around one or both of the core legs 202A and 202B. In other cases, the primary winding P₁ can be implemented as individual metal layers in the PCB, with each metal layer including two or more turns around one or both of the core legs 202A and 202B.

The secondary winding S₁ includes two turns (e.g., N_{1S1}=2) around the first core leg 202A and four turns (e.g., N_{2S1}=4) around the second core leg 202B, for a total of six turns (e.g., N_{1S1}+N_{2S1}=6) around the core legs 202A and 202B. In other cases, the total number of turns of the secondary winding S₁, or N_{1S1}+N_{2S1}, can be greater or fewer than six. The secondary winding S₁ can be implemented in a variety of ways in the stack of metal layers of the PCB. For example, the secondary winding S₁ can be implemented as individual metal layers in the PCB, with each metal layer including a single turn around one or both of the core legs 202A and 202B. In other cases, the secondary winding S₁ can be implemented as individual metal layers in the PCB, with each metal layer including two or more turns around one or both of the core legs 202A and 202B.

The number of turns Nip of the primary winding P₁ around the first core leg 202A is different than the number of turns N_{2P1} of the primary winding P₁ around the second core leg 202B. Also, the number of turns N_{1S2} of the secondary winding S₁ around the first core leg 202A is different than the number of turns N_{2S1} of the secondary winding S₁ around the second core leg 202B. The unequal distribution of N_{1P1} and N_{2P1} and unequal distribution of N_{1S1} and N_{2S1} can be relied upon to control or tailor the Lₚ₁ and Lₛ₁ inductances of the unit transformer 220A.

The winding or turning direction of the primary winding P₁ and the secondary winding S₁ around the core legs 202A and 202B is also shown in FIG. 5A. In FIG. 5A, the dot “.” signifies current flowing out of the page, and the “X” signifies current flowing into the page. The primary winding P₁ extends in a counter-clockwise direction around the first core leg 202A and extends in a clockwise direction around the second core leg 202B. The secondary winding S₁ extends in a clockwise direction around the first core leg 202A and extends in a counter-clockwise direction around the second core leg 202B. Thus, the magnetic flux 230 generated by the primary winding P₁ circulates in a clockwise direction among the “C” core component 200 and the “I” core component 208 as shown in FIG. 5A. Any magnetic flux 232 generated by the secondary winding S₁ would circulate in a counter-clockwise direction among the “C” core component 200 and the “I” core component 208.

Based on the arrangement and turning directions of the primary winding P₁ and the secondary winding S₁ around the core legs 202A and 202B in the unit transformer 220A, the unit transformer 220A can be described as a type A unit transformer. The unit transformer 220B is designed to have a different arrangement and turning direction of the primary winding P₁ and the secondary winding S₁.

FIG. 5B illustrates a representative example of the windings and magnetic core of the unit transformer 220B. The unit transformer 220B includes the magnetic “CI” core with the “C” core component 200 and the “I” core component 208. As shown in FIG. 5B, the “C” core component 200 also includes a first core leg 204A and a second core leg 204B. The first core leg 204A and the second core leg 204B comprise a pair of core legs in the unit transformer 220B, and the primary winding P₂ and the secondary winding S₂ extend or wind around the core legs 204A and 204B.

The primary winding P₂ and the secondary winding S₂ extend or wind around the first core leg 204A and around the second core leg 204B. In one example, the primary winding P₂ and the secondary winding S₂ of the unit transformer 220B can be embodied as a stack of metal layers in a PCB, including through-PCB vias and metal traces to electrically couple the P₂ windings together and to electrically couple the S₂ windings together in the PCB as needed. The PCB can include any number of metal layers in the stack, as needed, to implement the number of windings and turns described herein, along with dielectric insulating materials among them in a laminated structure. In some cases, the same PCB can be relied upon to implement the primary windings P₁ and P₂ and the secondary windings S₁ and S₂ in both the unit transformers 220A and 220B. The turns of the primary winding P₂ and the secondary winding S₂ are interleaved among each other around the core legs 204A and 204B in the example shown in FIG. 5B. The unit transformer 220B is not limited to the particular interleaving arrangement shown in FIG. 5B, however, and other interleaving arrangements can be relied upon.

In the example shown in FIG. 5B, the primary winding P₂ includes four turns (e.g., N_{1P2}=4) around the first core leg 204A and two turns (e.g., N_{2P2}=2) around the second core leg 204B, for a total of six turns (e.g., N_{1P2}+N_{2P2}=6) around the core legs 204A and 204B. In other cases, the total number of turns of the primary winding P₂, or N_{1P2}+N_{2P2}, can be greater or fewer than six. The primary winding P₂ can be implemented in a variety of ways in the stack of metal layers of the PCB. For example, the primary winding P₂ can be implemented as individual metal layers in the PCB, with each metal layer including a single turn around one or both of the core legs 204A and 204B. In other cases, the primary winding P₂ can be implemented as individual metal layers in the PCB, with each metal layer including two or more turns around one or both of the core legs 204A and 204B.

The secondary winding S₂ includes two turns (e.g., N_{1S2}=2) around the first core leg 204A and four turns (e.g., N_{2S2}=4) around the second core leg 204B, for a total of six turns (e.g., N_{1S2}+N_{2S2}=6) around the core legs 204A and 204B. In other cases, the total number of turns of the secondary winding S₂, or N_{1S2}+N_{2S2}, can be greater or fewer than six. The secondary winding S₂ can be implemented in a variety of ways in the stack of metal layers of the PCB. For example, the secondary winding S₂ can be implemented as individual metal layers in the PCB, with each metal layer including a single turn around one or both of the core legs 204A and 204B. In other cases, the secondary winding S₂ can be implemented as individual metal layers in the PCB, with each metal layer including two or more turns around one or both of the core legs 204A and 204B.

The number of turns N_{1P2} of the primary winding P₂ around the first core leg 204A is different than the number of turns N_{2P2} of the primary winding P₂ around the second core leg 204B. Also, the number of turns N_{1S2} of the secondary winding S₂ around the first core leg 204A is different than the number of turns N_{2S2} of the secondary winding S₁ around the second core leg 204B. The unequal distribution of N_{1P2} and N_{2P2} and unequal distribution of N_{1S2} and N_{2S2} can be relied upon to control or tailor the Lₚ₂ and Lₛ₂ inductances of the unit transformer 220B.

The winding or turning direction of the primary winding P₂ and the secondary winding S₂ around the core legs 204A and 204B is also shown in FIG. 5B. In FIG. 5B, the dot “.” signifies current flowing out of the page, and the “X” signifies current flowing into the page. The primary winding P₂ extends in a clockwise direction around the first core leg 204A and extends in a counter-clockwise direction around the second core leg 204B. The secondary winding S₂ extends in a counter-clockwise direction around the first core leg 204A and extends in a clockwise direction around the second core leg 204B. Thus, the magnetic flux 240 generated by the primary winding P₂ circulates in a counter-clockwise direction among the “C” core component 200 and the “I” core component 208 as shown in FIG. 5B. Any magnetic flux 242 generated by the secondary winding S₁ would circulate in a clockwise direction among the “C” core component 200 and the “I” core component 208. Based on the arrangement and turning directions of the primary winding P₂ and the secondary winding S₂ around the core legs 204A and 204B in the unit transformer 220B, the unit transformer 220B can be described as a type B unit transformer.

The unit transformer 220C shown in FIG. 5C can be implemented as a type A transformer, similar to that shown in FIG. 5A but replacing the primary winding P₁ with the primary winding P₃ and replacing the secondary winding S₁ with the secondary winding S₃. FIG. 5C illustrates a representative example of the primary winding P₃ and the secondary winding S₃ and the magnetic core of the unit transformer 220C. As shown in FIG. 5C, the unit transformer 220C is implemented as a type A transformer, similar to the unit transformer 220A shown in FIG. 5A, but replacing the primary winding P₁ with the primary winding P₃ and replacing the secondary winding S₁ with the secondary winding S₃.

When used in the power converter 10, the unit transformers 220A-220C shown in FIGS. 5A-5C can be electrically connected in series, similar to the way that the unit transformers 20A-20C are connected in FIG. 3. That is, the primary winding P₁ is series-connected with the primary winding P₂, and the primary winding P₂ is series-connected with the primary winding P₃. Thus, the primary windings P₁-P₃, collectively, form a single primary winding path across nodes A and B of the converter stage 14 shown in FIG. 1. Additionally, the secondary winding S₁ is series-connected with the secondary winding S₂, and the secondary winding S₂ is series-connected with the secondary winding S₃. Thus, the secondary windings S₁-S₃, collectively, form a single secondary winding path across nodes C and D of the converter stage 16 shown in FIG. 1.

However, in other cases, the primary and secondary windings of the unit transformers 220A-220C shown in FIGS. 5A-5C can be electrically coupled together in other ways. For example, the primary windings P₁-P₃ can be connected in series across nodes A and B of the converter stage 14, and the secondary windings S₁-S₃ can be respectively connected in parallel across nodes C and D of the converter stage 16. Alternatively, the primary windings P₁-P₃ can be respectively connected in parallel across nodes A and B of the converter stage 14, and the secondary windings S₁-S₃ can be connected in series across nodes C and D of the converter stage 16.

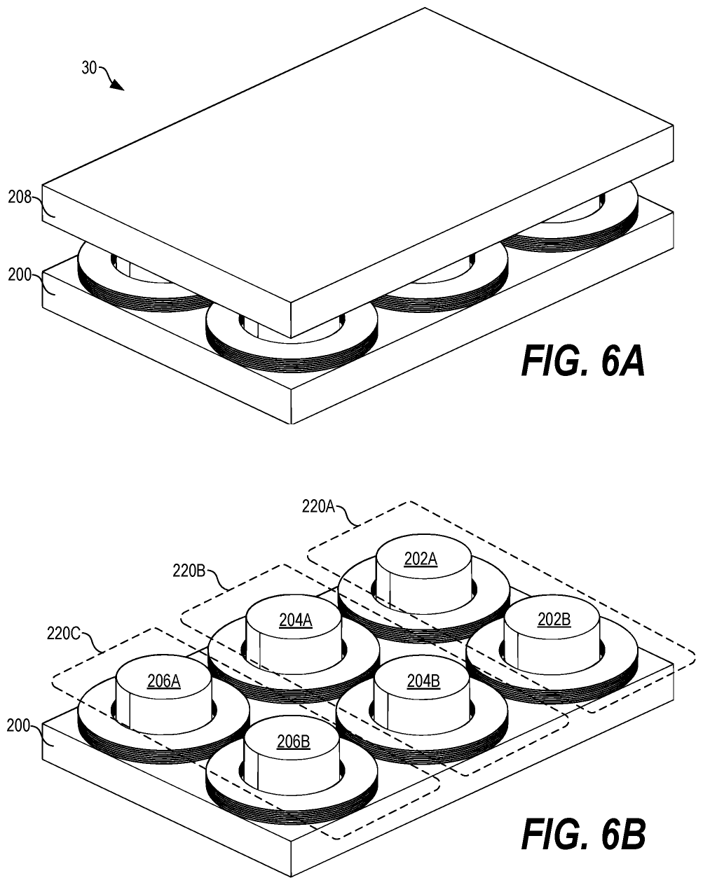

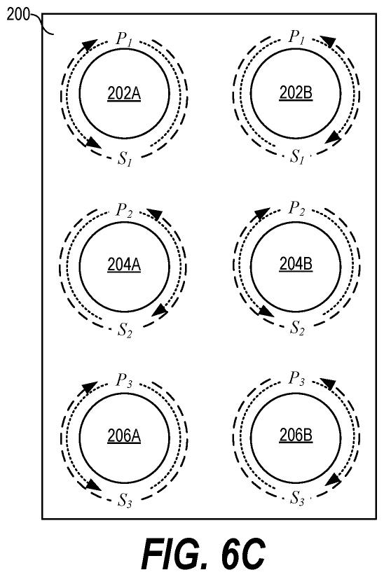

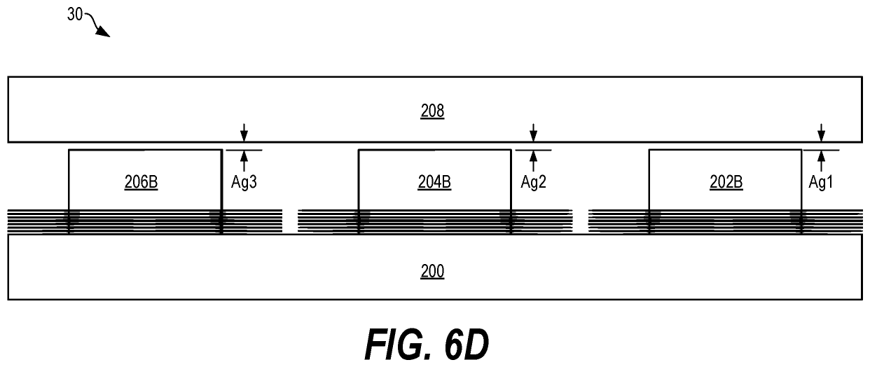

FIG. 6A illustrates an example of an integrated transformer 30 of the unit transformers 220A-22C shown in FIGS. 5A-5C, and FIG. 6B illustrates an example of the integrated transformer 30 shown in FIG. 6A with the “I” core component 208 omitted from view. The magnetic core of the integrated transformer 30 can be embodied as a material of high magnetic permeability, such as a ferromagnetic material like iron, laminated silicon steel, laminated iron sheets, or other solid or laminated ferromagnetic ceramic, metal, metal alloy, or related material(s). The core component 200 is referenced as a type of “C” core component with reference to each of the unit transformers 220A-220C, but the core component 200 includes more core legs than a typical “C” core. The core component 300 includes the first pair of core legs 202A and 202B for the unit transformer 220A, the second pair of core legs 204A and 204B for the unit transformer 220B, and the third pair of core legs 206A and 206B for the unit transformer 220C. As best shown in FIG. 5B, the core component 200 is formed as an integrated combination of three “C” cores, merged together.

The stacks of the primary windings P₁-P₃ and the secondary windings S₁-S₃ are illustrated as a representative example in FIGS. 6A and 6B. The electrical connections among the primary windings P₁-P₃ and the secondary windings S₁-S₃ are omitted from view in FIGS. 6A and 6B for simplicity. In practice, the primary windings P₁-P₃ and the secondary windings S₁-S₃ can be formed in other sizes, shapes, and styles. In one example, the primary windings P₁-P₃ and the secondary windings S₁-S₃ of the integrated transformer 30 can be embodied as a stack of metal layers in a PCB, including through-PCB vias and metal traces to electrically couple the windings together in the PCB as needed. The PCB can include any number of metal layers in the stack, as needed, to implement the number of windings and turns described herein, along with dielectric insulating materials among them (not shown) in a laminated structure. In other examples, the windings of the integrated transformer 30 can be implemented using wires (e.g., solid or stranded magnet wire, Litz wire, etc.), copper bars or layers, or in other ways.

As described above, the unequal or unbalanced distribution of the primary winding P₁ and the secondary winding S₁ around the core legs 202A and 202B results in leakage flux. Similarly, the unequal or unbalanced distribution of the primary winding P₂ and the secondary winding S₂ around the core legs 204A and 204B also results in leakage flux. The unequal or unbalanced distribution of the primary winding P₃ and the secondary winding S₃ around the core legs 206A and 206B also results in leakage flux. The leakage flux results in the series inductances Lₚ₁-Lₚ₃ and Lₛ₁-Lₛ₃. The inductances Lₚ₁-Lₚ₃ and Lₛ₁-Lₛ₃ can be relied upon, along with the capacitances Cₚ and Cₛ, as resonant tanks in the power converter 10.

Because the unit transformer 220B is a type B unit transformer, with windings that are wound around the core legs 204A and 204C in a winding direction that is opposite the winding direction of the windings of the unit transformers 220A and 220B around the core legs 202A, 202B, 206A, and 206B, the integrated transformer 30 experiences a net reduction in the total amount of leakage flux that flows in the core components 200 and 208. In other words, in terms of the total leakage flux density in the integrated transformer 30, the leakage flux attributed to the unit transformer 220B cancels or opposes at least some of the leakage flux attributed to the unit transformers 220A and 220C. As shown in FIGS. 5A-5C, the flux through the core components 200 and 208 for the unit transformer 220B flows in a direction that is opposite to that for the unit transformers 220A and 220C, resulting in a net reduction of the total leakage flux density in the integrated transformer 30.

To further illustrate the arrangement of the primary windings P₁-P₃ and the secondary windings S₁-S₃ in the integrated transformer 30, FIG. 6C illustrates a top down view of the core component 200 and winding turn directions in the integrated transformer 30. As shown in FIG. 6C, the primary winding P₁ extends in a counter-clockwise direction around the core leg 202A and extends in a clockwise direction around the core leg 202B. The primary winding P₂ extends in a clockwise direction around the core leg 204A and extends in a counter-clockwise direction around the core leg 204B. The primary winding P₃ extends in a counter-clockwise direction around the core leg 206A and extends in a clockwise direction around the core leg 206B. The secondary winding S₁ extends in a clockwise direction around the core leg 202A and extends in a counter-clockwise direction around the core leg 202B. The secondary winding S₂ extends in a counter-clockwise direction around the core leg 204A and extends in a clockwise direction around the core leg 204B. The secondary winding S₃ extends in a clockwise direction around the core leg 206A and extends in a counter-clockwise direction around the core leg 206B. In other words, the winding direction (i.e., clockwise vs. counter-clockwise) of the primary winding is alternated between adjacent (i.e., orthogonally-adjacent (and not diagonally-adjacent)) core legs among the core legs 202A, 202B, 204A, 204B, 206A, and 206B. Additionally, the winding direction of the secondary winding is alternated between adjacent core legs among the core legs 202A, 202B, 204A, 204B, 206A, and 206B.

Based on this winding arrangement, the leakage flux generated by the unit transformer 220B extends or flows in a direction that is opposite than that of the leakage flux generated by the unit transformers 220A and 220C, resulting in a net reduction (e.g., by leakage flux cancellation) of the total flux density and leakage flux density in the integrated transformer 30. The reduced flux density in the integrated transformer 30 results in reduced core loss, reduced heat dissipation, and other benefits in the integrated transformer 30. Additionally, with the reduced flux density, the overall size of the magnetic core of the integrated transformer 30 can be reduced. For example, the thicknesses of the top and bottom plates of the core components 200 and 208 can be reduced as compared to other designs. Additionally, the integrated transformer 30 does not include an auxiliary core leg, leading to a further reduction in the size of the integrated magnetics in the power converter 10. More particularly, the integrated transformer 30 is reduced in size and volume as compared to the integrated transformer 20.

FIG. 6D illustrates a side view of the integrated transformer 30 shown in FIG. 6A according to various aspects of the present disclosure. As shown, the integrated transformer 30 includes an air gap Ag1 between a top surface of the core leg 202B and the bottom surface of the “I” core component 208. The integrated transformer 30 also includes an air gap Ag2 between a top surface of the core leg 204B and the “I” core component 208 and an air gap Ag3 between a top surface of the core leg 206B and the “I” core component 208. Although not shown in FIG. 6D, the integrated transformer 30 also includes similar air gaps between the top surfaces of the core legs 202A, 204A, and 206A and the “I” core component 208.

In one example, the size or dimension of the air gaps Ag1, Ag2, and Ag3 (and all others in the integrated transformer 30) can be the same as each other. In other cases, one or more of the air gaps can be different than the others. For example, the air gap Ag2 for the core leg 204B and the corresponding air gap for the core leg 204A can be larger than the other air gaps in the integrated transformer 30. Generally, the integrated transformer 30 can include a first air gap for a first core leg that is different than a second air gap for a second core leg. In other cases, the integrated transformer 30 can include two, three, or more different air gaps. These and other variations can also be relied upon to control or tailor the inductances of Lₚ₁, Lₚ₂, and Lₚ₃ and the inductances of Lₛ₁, Lₛ₂, and Lₛ₃ in the integrated transformer 30. The other integrated transformer embodiments described herein can also include two, three, or more different air gaps in some cases to tailor the inductances of Lₚ₁, Lₚ₂, and Lₚ₃ and the inductances of Lₛ, Lₛ₂, and Lₛ₃.

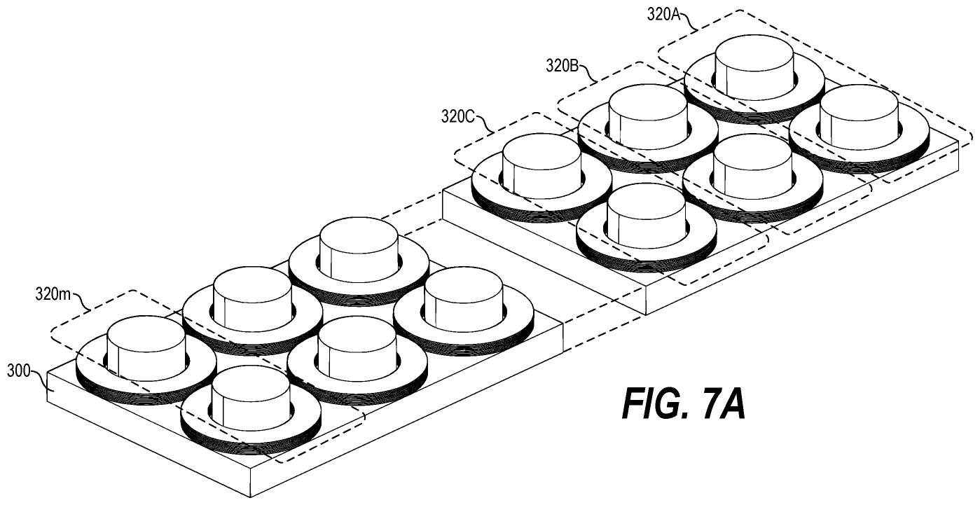

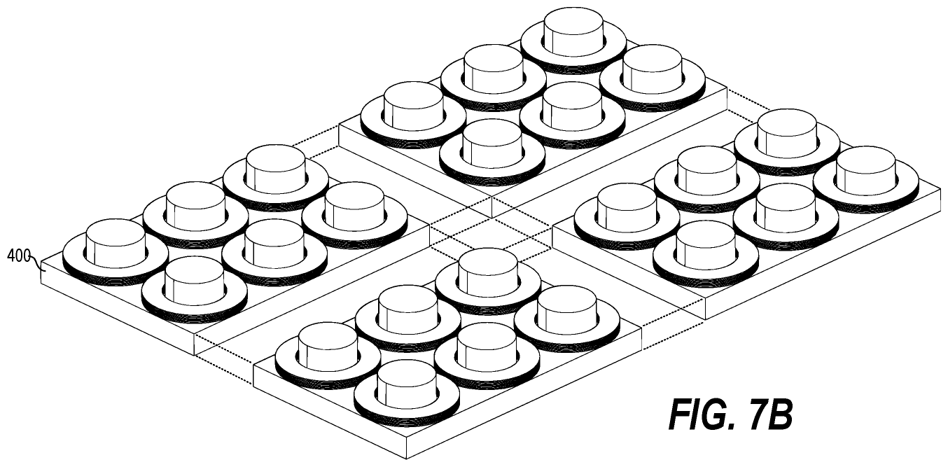

In other aspects, the embodiments described herein can be extended to larger integrated transformers and matrix integrated transformers of arbitrary size. FIG. 7A illustrates an example matrix integrated transformer according to various aspects of the present disclosure. The matrix integrated transformer is an extension of the integrated transformers 20 and 30 shown in FIGS. 4A, 4B, 6A, and 6B. FIG. 7A illustrates a core component 300, which is similar to the core components 100 and 200, as described above, but is extended in size and includes additional core legs. Although not shown in FIG. 7A, a flat or “I” core component can be placed over the core component 300.

In FIG. 7A, the core component 300 is illustrated with broken lines, indicating an arbitrary length or size of the core component 300. The core component 300 is sized to support a larger number of unit transformers, such as unit transformers 320A-320m. The unit transformer 320A can be implemented as a type A transformer, similar to the unit transformer 220A shown in FIGS. 5A and 6B. The unit transformer 320B can be implemented as a type B transformer, similar to the unit transformer 220B shown in FIGS. 5B and 6B. The remaining unit transformers can be alternated between type A and type B unit transformers, extending to the unit transformer 320m. The larger integrated transformer shown in FIG. 7A can be relied upon in the power converter 10, for example, among other power converters, to facilitate higher voltage, higher current, and higher power conversion applications.

FIG. 7B illustrates another example matrix integrated transformer according to various aspects of the present disclosure. The matrix integrated transformer is an extension of the integrated transformers 20 and 30 shown in FIGS. 4A, 4B, 6A, and 6B. FIG. 7B illustrates a core component 400, which is similar to the core components 100 and 200, as described above, but is extended in size and includes additional core legs. Although not shown in FIG. 7B, a flat or “I” core component can be placed over the core component 400. In FIG. 7B, the core component 400 is illustrated with broken lines, indicating an arbitrary length or size of the core component 400. The core component 400 is sized to support a larger number of unit transformers. The unit transformers can be implemented as alternating type A and type B transformers. In other words, the winding direction (i.e., clockwise vs. counter-clockwise) of the primary winding around the core legs of the core component 400 is alternated between adjacent (i.e., orthogonally-adjacent (and not diagonally-adjacent)) core legs of the core component 400. Additionally, the winding direction of the secondary winding is alternated between adjacent core legs among the core legs of the core component 400. The larger integrated transformer shown in FIG. 7B can be relied upon in the power converter 10, for example, among other power converters, to facilitate higher voltage, higher current, and higher power conversion applications.

In other embodiments, the integrated transformers described herein can be implemented using other types, styles, shapes, and sizes of magnetic cores. For example, the sizes, shapes, and other characteristics of the core legs in the integrated transformers described herein can vary as compared to the examples described above. The magnetic cores in the integrated transformers can also include a number of auxiliary core legs distributed around the outer edges or sides of the magnetic cores. Additionally, the air gaps between the core legs and the “I” core component of the magnetic cores in the integrated transformers can vary as compared to each other, as described above with reference to FIG. 6D.

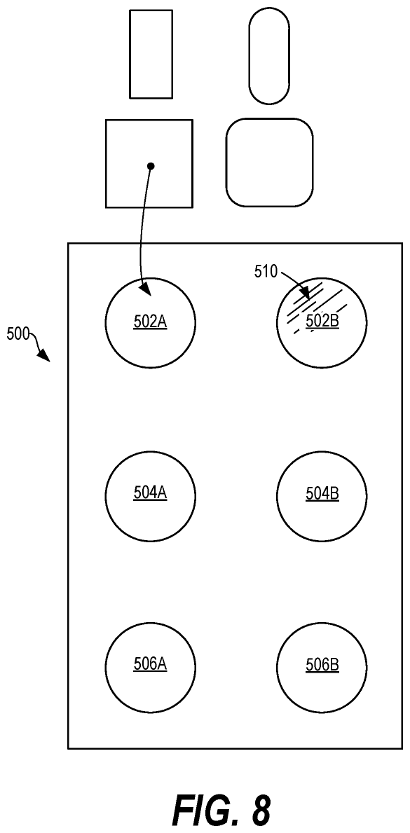

FIG. 8 illustrates other example profiles of core legs according to various aspects of the present disclosure. FIG. 8 illustrates a top down view of a core component 500 including core legs 502A, 502B, 504A, 504B, 506A, and 506B. The core component 500 shown in FIG. 8 is similar to the core component 200 shown in FIGS. 6A-6C. Because each of the core legs 502A, 502B, 504A, 504B, 506A, and 506B is cylindrical in shape, the top surfaces of each of the core legs 502A, 502B, 504A, 504B, 506A, and 506B are circular in profile and have the same size. For example, the top surface 510 (e.g., sectional area) of the core leg 502B is individually referenced in FIG. 8, and it is circular in shape. However, the integrated transformers described herein can also be implemented with magnetic cores including other shapes and sizes of core legs. For example, the core legs of the magnetic cores can have circular profiles, square profiles, rectangular profiles, square profiles with rounded corners, or rectangular profiles with rounded ends, as shown in FIG. 8. The legs of the magnetic cores are not limited to those shapes, however, and other profile shapes can be relied upon.

Additionally, in some cases, the profiles the core legs 502A, 502B, 504A, 504B, 506A, and 506B can vary as compared to each other. For example, one or more of the core legs can be circular in profile, and another one or more of the core legs can be square in profile. In other words, the core component 500 can include core legs having two different profile shapes. The core component 500 can also include core legs having three, four, or more different profile shapes. Additionally, the core component 500 can also include core legs having different sizes as compared to each other. For example, the top surface 510 of the core leg 502B (i.e., the sectional area of the top surface 510) can be larger or smaller than the top surface of the core leg 502A. The core component 500 can also include core legs having three, four, or more different top surface areas.

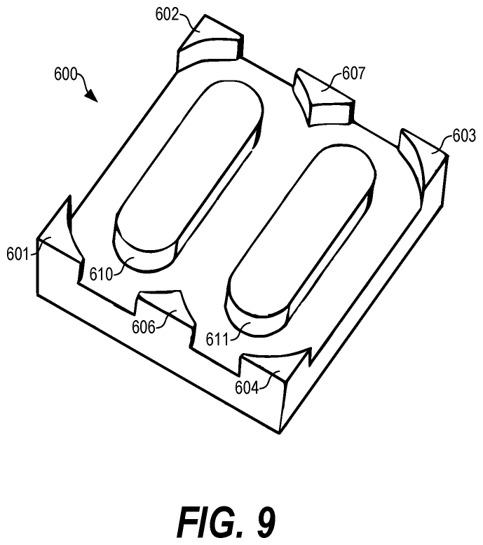

FIG. 9 illustrates another example magnetic core component 600 according to various aspects of the present disclosure. The magnetic core component 600 includes corner auxiliary legs 601-604 and side edge auxiliary legs 606 and 607. The magnetic core component 600 also includes a first core leg 610 and a second core leg 611. Three or more core components similar to the magnetic core component 600 can form the magnetic core of an integrated transformer according to the embodiments described herein. The magnetic core component 600 provides an example in which auxiliary legs can be positioned in a different way to distribute leakage flux. The corner auxiliary legs 601-604 are positioned at the corners of the magnetic core component 600 and have a triangular profile with two straight sides adjoined at a right angle and a semi-circular side. The side edge auxiliary legs 606 and 607 are positioned at opposite sides of the magnetic core component 600, between the first leg 610 and the second leg 611, and have a triangular profile with two semi-circular sides and a straight side.

Overall, the use of additional auxiliary legs positioned at the sides, the corners, along the peripheral sides, or at other locations around the legs around which the primary, secondary, and shield windings extend can provide better distribution of leakage flux in the integrated transformers described herein. Leakage flux can be distributed among the additional auxiliary legs, and the increased distribution of the leakage flux can result in reduced core loss as compared to magnetic cores with only a single auxiliary leg. The auxiliary legs shown in FIG. 9 can be incorporated into the magnetic core components 100, 200, 300, 400, or 500 and used in an integrated transformer in the power converter 10, among others, according to the embodiments.

The controllers described herein, including the controller 12, can be embodied as processing circuitry, including memory, configured to control the operation of the power converters, with or without feedback. The controllers can be embodied as any suitable type of controller, such as a proportional integral derivative (PID) controller, a proportional integral (PI) controller, or a multi-pole multi-zero controller, among others, to control the operations of the power converters. The controllers can be realized using a combination of processing circuitry and referenced as a single controller. It should be appreciated, however, that the controllers can be realized using a number of controllers, control circuits, drivers, and related circuitry, operating with or without feedback.

One or more microprocessors, microcontrollers, or DSPs can execute software to perform the control aspects of the embodiments described herein, such as the control aspects performed by the controller 12. Any software or program instructions can be embodied in or on any suitable type of non-transitory computer-readable medium for execution. Example computer-readable mediums include any suitable physical (i.e., non-transitory or non-signal) volatile and non-volatile, random and sequential access, read/write and read-only, media, such as hard disk, floppy disk, optical disk, magnetic, semiconductor (e.g., flash, magneto-resistive, etc.), and other memory devices. Further, any component described herein can be implemented and structured in a variety of ways. For example, one or more components can be implemented as a combination of discrete and integrated analog and digital components.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure. Other aspects and embodiments of the integrated transformers described herein are also detailed in the paper titled “A Single Phase CLLC Resonant Converter with a Novel Matrix Integrated Transformer,” 2022 IEEE Energy Conversion Congress and Exposition (ECCE), DOI: 10.1109/ECCE50734.2022.9948196, the entire contents of which is hereby incorporated herein by reference.

What is claimed is:

1. A power converter, comprising:
a primary-side converter stage and secondary-side converter stage; and
an integrated transformer electrically coupled between the primary-side converter stage and the secondary-side converter stage, comprising:
a magnetic core comprising plurality of core legs; and
a primary winding extending around each of the plurality of core legs and a secondary winding extending around each of the plurality of core legs, wherein:
a winding direction of the primary winding is alternated between adjacent core legs among the plurality of core legs; and
a number of winding turns of the primary winding around the plurality of core legs is different on at least two core legs among the plurality of core legs.

2. The power converter according to claim 1, wherein a winding direction of the secondary winding is alternated between adjacent core legs among the plurality of core legs.

3. The power converter according to claim 1, wherein a number of winding turns of the secondary winding around the plurality of core legs is different on at least two core legs among the plurality of core legs.

4. The power converter according to claim 1, wherein a total number of winding turns of the primary winding and the secondary winding around a first core leg is different than around a second core leg among the plurality of core legs.

5. The power converter according to claim 1, wherein the magnetic core comprises a first air gap for a first core leg among the plurality of core legs and a second, different air gap for a second core leg among the plurality of core legs.

6. The power converter according to claim 1, wherein:
the integrated transformer comprises a first unit transformer and a second unit transformer;
the first unit transformer comprises a first total number of winding turns of the primary winding and the secondary winding around a first pair of core legs among the plurality of core legs; and
the second unit transformer comprises a second, different total number of winding turns of the primary winding and the secondary winding around a second pair of core legs among the plurality of core legs.

7. The power converter according to claim 1, wherein:
the integrated transformer comprises a first unit transformer, a second unit transformer, and a third unit transformer;
a first polarity of magnetomotive force (MMF) of the first unit transformer and of the third unit transformer is different than a second polarity of the MMF of the second unit transformer.

8. The power converter according to claim 1, wherein:
the integrated transformer comprises a first unit transformer and a second unit transformer;
the first unit transformer comprises a first primary winding and a first secondary winding; and
the second unit transformer comprises a second primary winding and a second secondary winding.

9. The power converter according to claim 8, wherein:
the first primary winding and the second primary winding are series connected between nodes of the primary-side converter stage; and
the first secondary winding and the second secondary winding are series connected between nodes of the secondary-side converter stage.

10. The power converter according to claim 8, wherein:
the first primary winding and the second primary winding are series connected between nodes of the primary-side converter stage; and
the first secondary winding and the second secondary winding are parallel connected between nodes of the secondary-side converter stage.

11. The power converter according to claim 8, wherein:
the first primary winding and the second primary winding are parallel connected between nodes of the primary-side converter stage; and
the first secondary winding and the second secondary winding are series connected between nodes of the secondary-side converter stage.

12. The power converter according to claim 1, wherein the plurality of core legs in the magnetic core are arranged in a matrix of core legs.

13. The power converter according to claim 1, wherein the plurality of core legs comprise at least two core legs having different profile shapes.

14. The power converter according to claim 1, wherein the plurality of core legs comprise at least two core legs having different sectional surface areas.

15. An integrated transformer, comprising:
a magnetic core comprising plurality of core legs; and
a primary winding extending around each of the plurality of core legs and a secondary winding extending around each of the plurality of core legs, wherein:
a winding direction of the primary winding is alternated between adjacent core legs among the plurality of core legs;
a winding direction of the secondary winding is alternated between adjacent core legs among the plurality of core legs;
a number of winding turns of the primary winding around the plurality of core legs is different on at least two core legs among the plurality of core legs; and
the integrated transformer exhibits a primary-side inductor and a second-side inductor.

16. The integrated transformer according to claim 15, wherein a number of winding turns of the secondary winding around the plurality of core legs is different on at least two core legs among the plurality of core legs.

17. The integrated transformer according to claim 15, wherein a total number of winding turns of the primary winding and the secondary winding around a first core leg is different than around a second core leg among the plurality of core legs.

18. The integrated transformer according to claim 15, wherein the magnetic core comprises a first air gap for a first core leg among the plurality of core legs and a second, different air gap for a second core leg among the plurality of core legs.

19. The integrated transformer according to claim 15, wherein:
the integrated transformer comprises a first unit transformer and a second unit transformer;
the first unit transformer comprises a first total number of winding turns of the primary winding and the secondary winding around a first pair of core legs among the plurality of core legs; and
the second unit transformer comprises a second, different total number of winding turns of the primary winding and the secondary winding around a second pair of core legs among the plurality of core legs.

20. The integrated transformer according to claim 15, wherein:
the integrated transformer comprises a first unit transformer, a second unit transformer, and a third unit transformer,
a first polarity of magnetomotive force (MMF) of the first unit transformer and of the third unit transformer is different than a second polarity of the MMF of the second unit transformer.
